(19) United States
(12) Patent Application Publication
(10) Pub. No.: US 2018/0173411 A1
(43) Pub. Date: Jun. 21, 2018

(54) DISPLAY DEVICE, DISPLAY METHOD, AND NON-TRANSITORY COMPUTER READABLE RECORDING MEDIUM

(71) Applicant: SHARP KABUSHIKI KAISHA, Sakai City (JP)

(72) Inventor: NORIYOSHI KANKI, Sakai City (JP)

(21) Appl. No.: 15/847,707

(22) Filed: Dec. 19, 2017

(30) Foreign Application Priority Data
Dec. 20, 2016 (JP) 2016-246989

(51) Int. Cl. G06F 3/0484; G06F 3/0483; G06F 3/0488

(52) U.S. Cl. CPC G06F 3/04847; G06F 3/0414; G06F 3/04883; G06F 3/0483

(57) ABSTRACT

A display device includes a sheet display unit that displays a sheet on which an object is to be arranged, an expansion menu display unit that displays an expansion menu for receiving an input operation, a determination unit that determines a direction in which the sheet is to be expanded on the basis of the input operation performed on the expansion menu, and a sheet expansion unit that increases sheet size of the sheet in the determined direction.

### BACKGROUND

### 1. Field

The present disclosure relates to a display device and the like.

### 2. Description of the Related Art

Display devices capable of displaying various objects using an input unit such as a touch panel are known. Such a display device is used as a whiteboard, for example, and objects are drawn and arranged on a drawing sheet.

When the blank space of a sheet runs out, a user might desire to expand the sheet. In Japanese Unexamined Patent Application Publication No. 2015-203989, for example, a technique for displaying a new handwriting input area outside one of a plurality of display areas in accordance with a handwriting input operation that has begun in the display area has been disclosed.

In Japanese Unexamined Patent Application Publication No. 2010-134897, a technique for scrolling through drawing information on a drawing screen by changing a drawing target area on the drawing screen in accordance with calculated parameters and drawing the drawing information again on the drawing screen in accordance with the new drawing target area has been disclosed.

In Japanese Unexamined Patent Application Publication No. 2013-178701, a technique for improving a drawing operation in the periphery of a display, such as around a task bar, has been disclosed.

### SUMMARY

As described above, the examples of the related art only simulatively make the user think that he/she has expanded a sheet. That is, a large sheet is virtually prepared in advance, and a part of the sheet is displayed to the user.

In this case, a virtual sheet is just scrolled, and a sheet is not actually expanded.

In addition, when the user desires to actually expand a sheet in the examples of the related art, the user needs to call an expansion menu from a list of menus or the like. It therefore takes time to expand a sheet, and operability is low.

The present disclosure provides a display device and the like capable of expanding a sheet on which an object can be arranged through a simple operation.

A display device in the present disclosure includes a sheet display unit that displays a sheet on which an object is to be arranged, an expansion menu display unit that displays an expansion menu for receiving an input operation, a determination unit that determines a direction in which the sheet is to be expanded on the basis of the input operation performed on the expansion menu, and a sheet expansion unit that increases sheet size of the sheet in the determined direction.

A display method in the present disclosure includes displaying a sheet in which an object is to be arranged, displaying an expansion menu for receiving an input operation, determining a direction in which the sheet is to be expanded on the basis of the input operation performed on the expansion menu, and increasing sheet size of the sheet in the determined direction.

A non-transitory computer-readable recording medium in the present disclosure stores a program for causing a computer to perform operations including displaying a sheet in which an object is to be arranged, displaying an expansion menu for receiving an input operation, determining a direction in which the sheet is to be expanded on the basis of the input operation performed on the expansion menu, and increasing sheet size of the sheet in the determined direction.

### BRIEF DESCRIPTION OF THE DRAWINGS

FIG. 1 is a diagram illustrating the appearance of a display device in the present disclosure;

FIG. 2 is a diagram illustrating a functional configuration according to a first embodiment;

FIGS. 3A and 3B are diagrams illustrating an example of a data configuration according to the first embodiment;

FIGS. 4A to 4C are diagrams illustrating an outline of an expansion menu according to the first embodiment;

FIGS. 5A and 5B are diagrams illustrating an outline of an operation for expanding a sheet according to the first embodiment;

FIG. 6 is an operation flowchart illustrating a main process according to the first embodiment;

FIG. 7 is an operation flowchart illustrating a process for expanding a sheet according to the first embodiment;

FIG. 8 is an operation flowchart illustrating a process for updating the expansion menu according to the first embodiment;

FIG. 9 is an operation flowchart illustrating a process for updating a displayed sheet according to the first embodiment;

FIGS. 10A to 10C are diagrams illustrating an example of an operation according to the first embodiment;

FIGS. 11A and 11B are diagrams illustrating an example of an operation according to a second embodiment;

FIG. 12 is a diagram illustrating an example of an operation according to a third embodiment;

FIG. 13 is an operation flowchart illustrating a process for updating an expansion menu according to a fourth embodiment;

FIGS. 14A and 14B are diagrams illustrating an example of an operation according to the fourth embodiment;

FIG. 15 is an operation flowchart illustrating a process for updating a displayed sheet according to a fifth embodiment;

FIGS. 16A and 16B are diagrams illustrating an example of an operation according to the fifth embodiment;

FIG. 17 is an operation flowchart illustrating a process for updating an expansion menu according to a sixth embodiment;

FIG. 18 is a diagram illustrating an example of an operation according to the sixth embodiment;

FIG. 19 is a diagram illustrating an expansion menu according to a seventh embodiment;

FIGS. 20A and 20B are diagrams illustrating an example of an operation according to an eighth embodiment;

FIG. 21 is an operation flowchart illustrating a process for expanding a sheet according to a ninth embodiment;

FIG. 22 is an operation flowchart illustrating a main process according to a tenth embodiment;

FIGS. 23A and 23B are diagrams illustrating an example of an operation according to the tenth embodiment;

FIG. 24 is a diagram illustrating an example of an operation according to an eleventh embodiment;

FIG. 25 is an operation flowchart illustrating a main process according to a twelfth embodiment;

FIGS. 26A and 26B are diagrams illustrating an example of an operation according to the twelfth embodiment; and

FIG. 27 is a diagram illustrating the appearance of display devices according to a thirteenth embodiment.

### DESCRIPTION OF THE EMBODIMENTS

Embodiments of the present disclosure will be described hereinafter with reference to the drawings. Although the embodiments will be described while taking as an example a case in which a display device in the present disclosure is a terminal device including a touch panel for convenience of description, the display device may be any type of device insofar as a user can draw and arrange objects using the display device.

### 1. First Embodiment

### 1.1 Overall Configuration

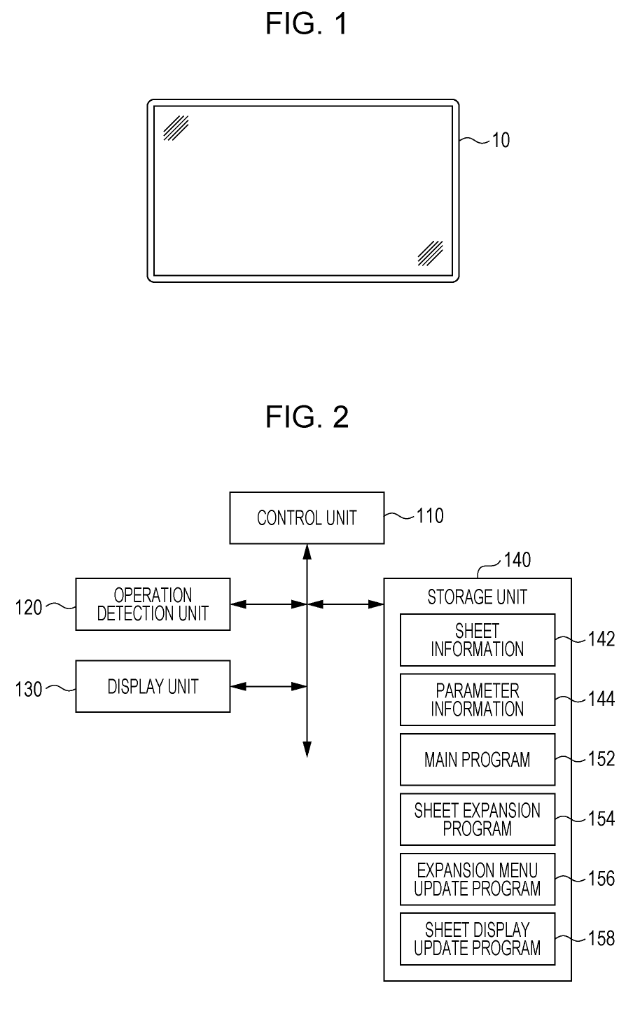

FIG. 1 illustrates the appearance of a display device 10, which is a display device in the present disclosure. The display device 10 is a liquid crystal display (LCD), for example, and includes a touch panel with which the user can perform touch input.

The touch panel receives input operations performed by the user, such as a touch, a flick, and a slide. The touch panel may employ an electrostatic capacitance method or a pressure sensing method. That is, the display device may be any type of device capable of receiving input operations performed by the user, such as a touch.

The display device 10 is not limited to a common touch panel display, but may be a device such as a computer, a tablet terminal, a smartphone, or an automotive navigation system.

### 1.2 Functional Configuration

FIG. 2 illustrates the functional configuration of the display device 10 according to a first embodiment. As illustrated in FIG. 2, the display device 10 includes a control unit 110, an operation detection unit 120, a display unit 130, and a storage unit 140.

The control unit 110 is a functional component for controlling the entirety of the display device 10. The control unit 110 is a central processing unit (CPU), for example, and achieves various functions by reading various programs stored in the storage unit 140.

When configured as a touch panel, the control unit 110 also displays objects drawn and input through a display screen (operation detection unit 120), such as images, and controls how images input from other image input devices are displayed.

The operation detection unit 120 is a functional component for detecting operations performed by the user. The operation detection unit 120 is, for example, a touch panel integrated with the display unit 130. The operation detection unit 120 may employ any method for detecting operations, such as an electrostatic capacitance method, a pressure sensing method such as a resistive film method, an infrared method, or an electromagnetic induction method.

The display unit 130 is a functional component for displaying, to a user, various pieces of information and sheets on which objects are drawn or arranged. The display unit 130 is, for example, an LCD or an organic electroluminescent (EL) display.

The storage unit 140 is a functional component storing various programs and various pieces of data used to operate the display device 10. The storage unit 140 is, for example, a semiconductor memory such as a solid-state drive (SSD) or a magnetic disk such as a hard disk drive (HDD).

The storage unit 140 stores sheet information 142, parameter information 144, a main program 152, a sheet expansion program 154, an expansion menu update program 156, and a sheet display update program 158.

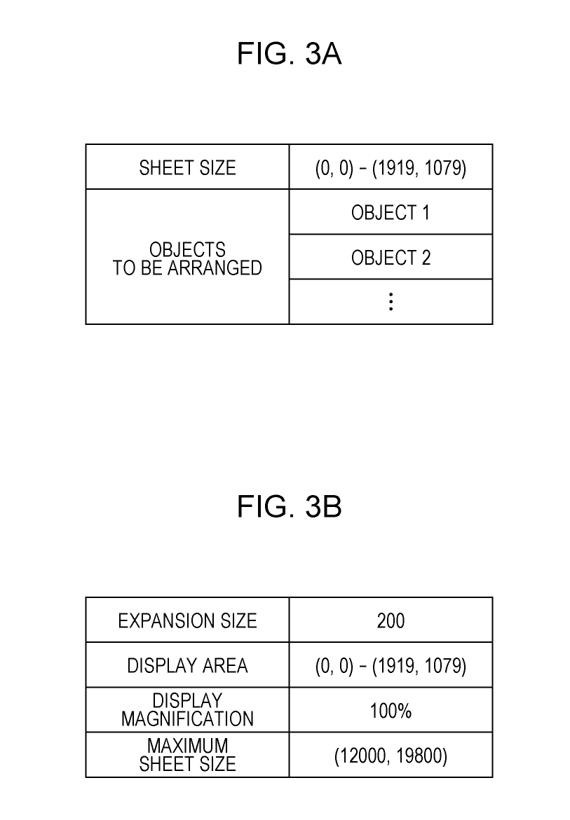

The sheet information 142 is information regarding sheets. As illustrated in FIG. 3A, the sheet information 142 is information regarding a sheet size (e.g., “(0, 0)-(1919, 1079)”) and objects to be arranged.

A sheet herein refers to image data, a layer, or a canvas on which various objects can be arranged or drawn. When the user draws a handwritten object, the handwritten object is provided on a sheet.

The sheet size usually matches the size of a display area based on the display unit 130. The user can use the sheet like an electronic blackboard to arrange or draw objects.

There may be a plurality of sheets. In this case, the user can display another sheet by performing a certain operation (e.g., a swipe).

As described above, the sheet size often matches the size of the display area, but may be different from the size of the display area. In this case, an object larger than the sheet size can be arranged or drawn, and even when the display area is not large enough to display the entirety of an object, the user can arrange or draw the object in an additional area.

The sheet size refers to the size of a sheet, and the sheet information 142 includes information regarding the size of a sheet. In FIG. 3A, length and width are stored as an example of the sheet size. Alternatively, coordinates (relative coordinates or absolute coordinates) may be stored, or the number of pixels may be stored. If a sheet is a file, attributes of the file may be referred to.

In the field of “objects to be arranged”, objects to be arranged on a sheet are stored. Objects can be objects drawn by the user or objects obtained by pasting another file. As the content of an object, coordinates at which the object is to be drawn, the size of the object, stroke data, text data, file data such as an image or a sound, document data, and the like are stored. Any known method may be used as a method for drawing an object on a sheet on the basis of information regarding the object.

An expression “expand a sheet” used herein means that the sheet size increases. More specifically, an expression “a sheet expands downward” used herein means that the sheet size increases downward.

The parameter information 144 includes parameters and attributes relating to sheets, parameters used when a program has been executed, and the like. As illustrated in FIG. 3B, for example, the parameter information 144 includes an expansion size (e.g., “200”), a display area (e.g., (0, 0)-(1919, 1079)), a display magnification (e.g., “100%”), and a maximum sheet size (e.g., “(12000, 19800)”).

The expansion size refers to a size by which a sheet is expanded in a process that will be described later. The expansion size may be defined by length and width or in upward, downward, leftward, and rightward directions. Although the expansion size is defined by the number of pixels in the present embodiment, the expansion size may be defined by percentage or any other variable set by the user, instead.

The display area refers to a part or the entirety of a sheet currently displayed on the display device 10. In the present embodiment, the display area is indicated by coordinates, which may be relative coordinates or absolute coordinates.

The display magnification refers to a magnification of a sheet relative to the display area. The display magnification is a magnification by which a sheet and objects arranged on the sheet are displayed and can be arbitrarily set by the user.

The maximum sheet size refers to a maximum size to which a sheet can be expanded. In the present embodiment, an operation for expanding a sheet is not accepted if the operation makes the sheet size larger than the maximum sheet size. As the maximum sheet size, a length and a width may be stored as illustrated in FIG. 3B, or a length or a width may be stored, instead. Depending on the system, the maximum sheet size need not be set.

The control unit 110 reads and executes the main program 152, the sheet expansion program 154, the expansion menu update program 156, and the sheet display update program 158 to achieve functions corresponding to the programs. Processes based on these programs will be described later.

Although the display device 10 solely performs display, drawing, and control in the present embodiment, another device may perform such operations, instead. For example, a drawing device (e.g., a computer) connected, through universal serial bus (USB) or High-Definition Multimedia Interface (HDMI; registered trademark), to a display device capable of detecting a touch may perform operations.

### 1.3 Basic Description

Next, concepts according to the present embodiment will be described. In the present embodiment, an expansion menu is displayed in the display area. The user touches (selects) a certain area (e.g., an expansion button in the present embodiment) in the expansion menu to expand a sheet in a direction corresponding to the certain area.

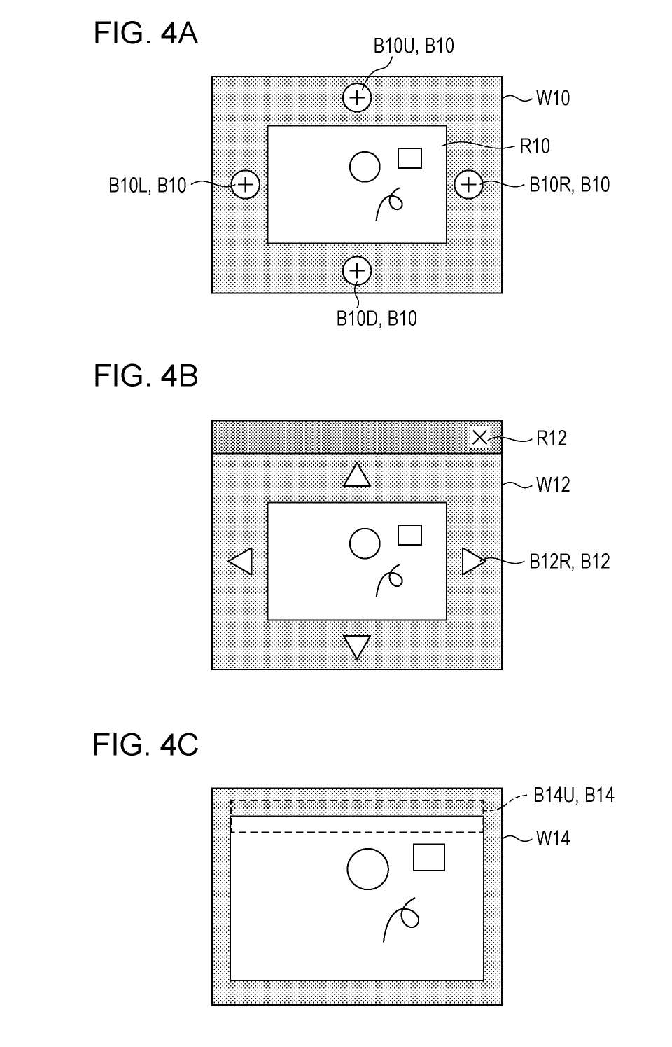

FIGS. 4A to 4C illustrate examples of the expansion menu. FIG. 4A illustrates an expansion menu W10 as a simple expansion menu. In the expansion menu W10, a preview image of the display area is displayed in an area R10. The preview image may be one that does not include a preview image or one that can display or remove a preview image.

Selection buttons B10 are displayed around the area R10. The selection buttons B10 are displayed above and below and to the left and right of the area R10. In the expansion menu W10, for example, an upward selection button B10U, a rightward selection button B10R, a downward selection button B10D, and a leftward selection button B10L are displayed.

Here, the user touches (selects) a selection button to increase the sheet size in a corresponding direction. Here, the expression “increase the sheet size” refers to expansion of an area in which the user can arrange objects.

When the sheet size is increased, the expansion menu may also be expanded, or may remain the same. When the expansion menu is expanded and displayed, the area R10 may also be expanded and displayed, or the preview image displayed in the area R10 may be displayed again with the same size. When the size of the expansion menu remains the same, the preview image displayed in the area R10 may be displayed again.

Alternatively, the expansion menu may be expanded or reduced through an operation performed by the user, or may be in another mode. As indicated by an expansion menu W12 illustrated in FIG. 4B, for example, shapes of selection buttons B12 may be different. In FIG. 4B, for example, the selection buttons B12R are triangular. In addition, an area R12 may be displayed as a button for closing the expansion menu W12. The area R12 for closing the expansion menu W12 may be one that can be displayed or removed or may be displayed or removed depending on the size of the expansion menu W12.

In addition, as indicated by an expansion menu W14 illustrated in FIG. 4C, selection buttons may be removed and a selection area B14 may be displayed. When the user has selected the selection area B14U on an upper end of the expansion menu W14, for example, it may be regarded that a selection button has been pressed. The user may select whether to display a selection button or a selection area or a selection button or a selection area may be displayed depending on the size of the expansion menu W14.

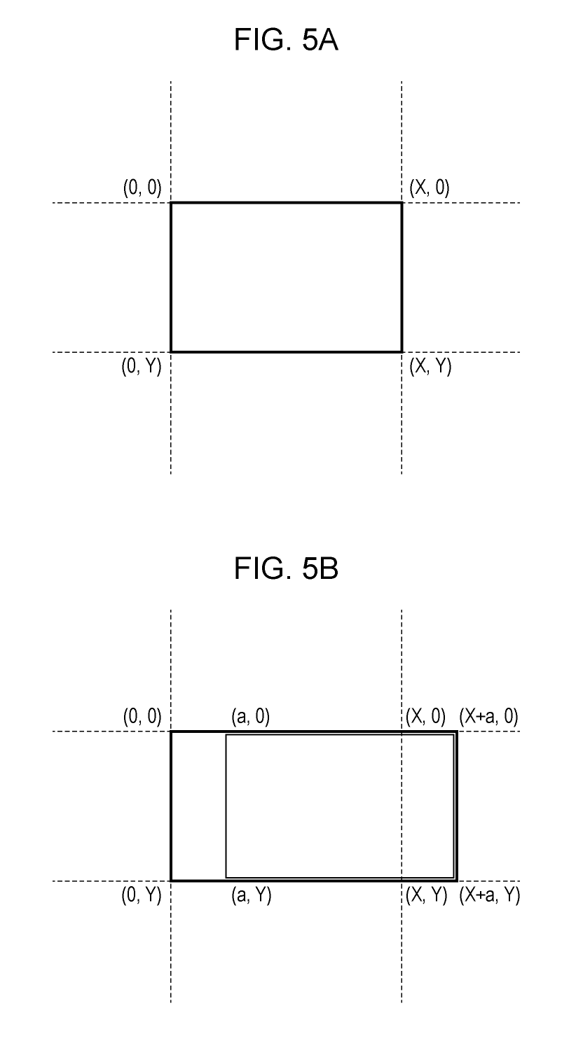

An operation for increasing the sheet size will be described with reference to FIGS. 5A and 5B. FIG. 5A is a diagram illustrating a basic state. A sheet is defined by coordinates (0, 0)-(X, Y). The coordinates may be relative coordinates or absolute coordinates. The sheet is indicated by a solid line. In this case, the display area and the sheet match.

If an operation for expanding a sheet rightward is performed, the sheet size increases as illustrated in FIG. 5B. That is, the sheet expands rightward by a defined expansion size. If the expansion size is included in the parameter information 144 as “a”, for example, the sheet size increases to (0, 0)-(X+a, Y).

As a method for increasing the sheet size, a method in which the sheet size is redefined by expanding the sheet rightward as coordinates, a method in which an expansion is determined as an expansion area and the sheet size is increased by adding the expansion area to a current area of the sheet, or the like may be used.

When the sheet size increases upward, for example, the sheet size increases from (0, 0)-(X, Y) to (0, 0−a)-(X, Y).

Although a sheet is expanded by the expansion size included in the parameter information 144 in the present embodiment, the expansion size may be calculated, instead. If a sheet is vertically expanded, for example, the sheet may be expanded by “the length of a default sheet size/4×the width of the sheet size”, and if a sheet is horizontally expanded, the sheet may be expanded by “the width of the default sheet size/4×the length of the sheet size”. That is, if an expansion direction is selected in this case, a sheet is expanded by a quarter of the default sheet size. A sheet may be expanded by another ratio, namely, for example, one-fifth or one-third, instead.

If the sheet size is already at its maximum when a sheet is to be expanded, the sheet need not be expanded.

In FIG. 5B, the display area is indicated by a thin line. That is, the display area is (a, 0)-(X+a, 0). Various methods, which will be described later, may be used to specify a part or the entirety of a sheet to be displayed in the display area.

In the present embodiment, the user can thus easily and intuitively increase the sheet size using the expansion menu. Since a minimum required sheet size is used, the amount of data used in a memory is small. The sheet size can be increased with a small load even in the case of a device whose processing speed is low and memory is small, such as a smartphone or a tablet.

### 1.4 Processing Flows

Next, processing flows according to the present embodiment will be described.

### 1.4.1 Main Process

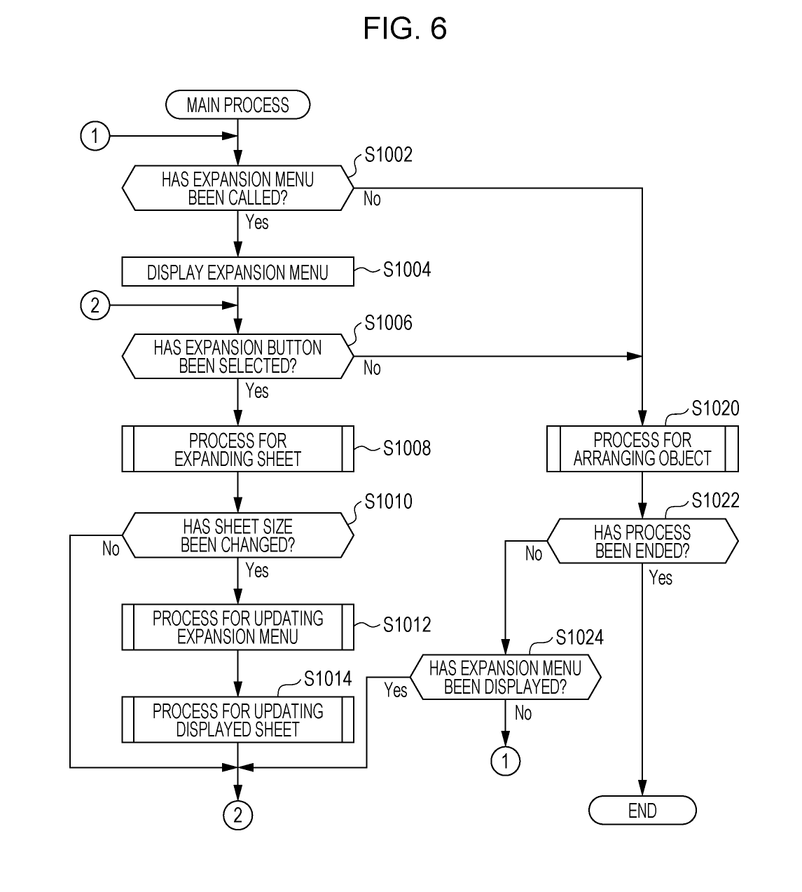

A main process will be described with reference to FIG. 6. The main process is achieved when the control unit 110 reads and executes the main program 152 stored in the storage unit 140.

First, if the expansion menu is called, the expansion menu is displayed (YES in step S1002→S1004).

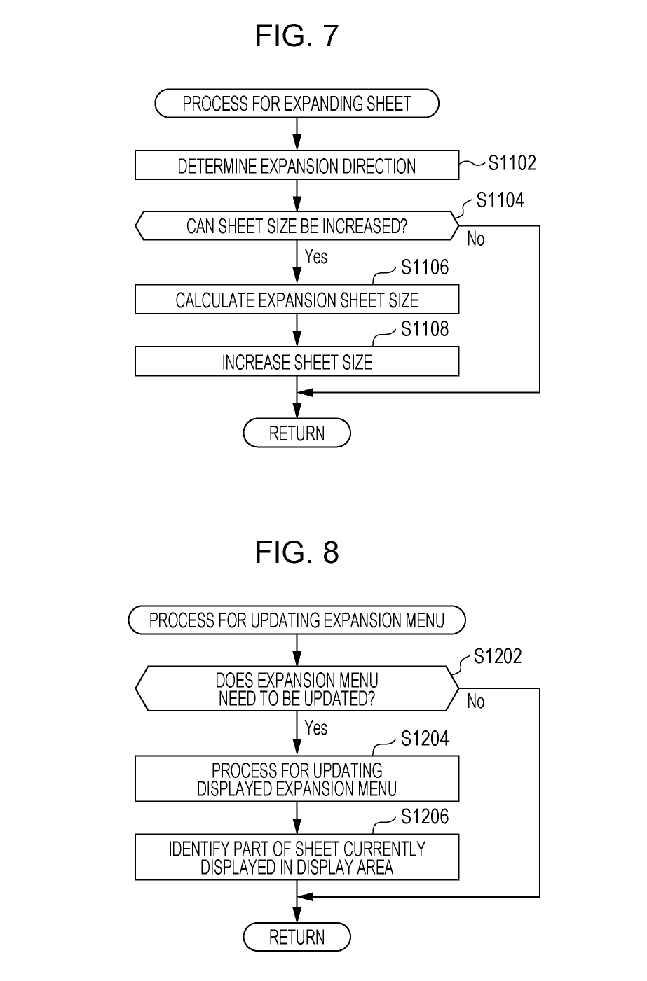

Next, if a button in the expansion menu is selected (e.g., touched) (YES in step S1006), a process for expanding a sheet is performed (step S1008). The process for expanding a sheet will be described with reference to FIG. 7.

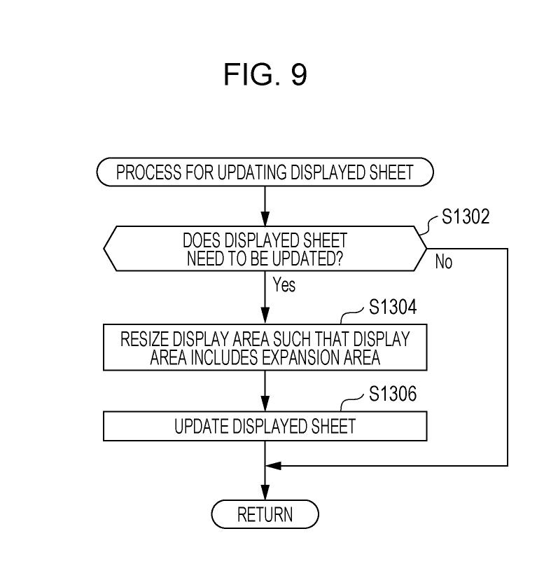

After the sheet size is changed as a result of the process for expanding a sheet (YES in step S1010), a process for updating the expansion menu (step S1012) and a process for updating a displayed sheet (step S1014) are performed. As a result, the expansion menu and the displayed sheet are updated on the basis of instructions from the user or predetermined settings. Details of these processes will be described with reference to FIGS. 8 and 9.

Although the process for updating a displayed sheet in step S1014 is performed after the process for updating the expansion menu in step S1012 is performed in the present embodiment, the order of the processes is not limited to this. That is, step S1014 may be performed before step S1012. Alternatively, steps S1012 and S1014 may be performed in parallel with each other.

The process is then performed again from step S1006. The displayed expansion menu may be removed again. If an operation for removing the expansion menu is performed after step S1014, for example, the expansion menu is removed, and the process is performed again from step S1002.

If the expansion menu is not called (NO in step S1002), or if the expansion menu is called but an expansion button is not selected, a process for arranging an object is performed (step S1020).

The process for arranging an object is performed by the user to arrange an object on a sheet. The user arranges a handwritten object by drawing the object, a text object by inputting text, or a content file such as a still image or a moving image with sound by pasting the content file. The user can move, change, expand or reduce, or remove an arranged object. The process for arranging an object is achieved by a conventional whiteboard function or the like, and detailed description thereof is omitted.

If the user performs an end operation, the main process ends (YES in step S1022). If the user continues the process, for example, a repetition operation is performed. More specifically, if the expansion menu is displayed (YES in step S1024), the process is performed again from step S1006. If the expansion menu is not displayed (NO in step S1024), the process is performed again from step S1002.

It is needless to say that the expansion menu can be moved and resized. Display attributes such as color and transparency can also be changed.

### 1.4.2 Process for Expanding Sheet

The process for expanding a sheet will be described with reference to FIG. 7. The process for expanding a sheet is achieved when the control unit 110 reads and executes the sheet expansion program 154 stored in the storage unit 140.

First, an expansion direction of the sheet size is determined (step S1102). In the present embodiment, one of displayed expansion buttons is selected to expand a sheet. That is, a direction corresponding to a selected expansion button is determined.

Next, whether the sheet size can be increased is determined (step S1104). In this determination, for example, whether a sheet size with which processing can be performed will be exceeded or whether the maximum sheet size set by the user will be exceeded is determined.

In the present embodiment, whether the sheet size will exceed the maximum sheet size is determined. The maximum sheet size is included in the parameter information 144. If the sheet size will exceed the maximum sheet size, it is determined that the sheet is not to be expanded.

If the sheet size can be increased (YES in step S1104), an expansion sheet size is calculated (step S1106). For example, an expansion size is read from the parameter information 144, an area to be added to the sheet in the direction determined in step S1102 is calculated, and the sheet size is increased (step S1108).

### 1.4.3 Process for Updating Expansion Menu

The process for updating the expansion menu will be described with reference to FIG. 8. The process for updating the expansion menu is achieved when the control unit 110 reads and executes the expansion menu update program 156 stored in the storage unit 140.

Whether the displayed expansion menu needs to be updated is determined (step S1202). Whether the displayed expansion menu needs to be updated is determined using one of various methods.

For example, whether a preview area is displayed in the expansion menu is determined. If a preview area is displayed in the expansion menu, it is determined that the displayed expansion menu needs to be updated. If a preview area is not displayed, it is determined that the displayed expansion menu need not be updated.

In addition, whether to resize the expansion menu is determined. If the expansion menu is to be resized, it may be determined that the displayed expansion menu needs to be updated. If the expansion menu is not to be resized, it may be determined that the displayed expansion menu need not be updated.

In the present embodiment, a process for updating the displayed expansion menu is performed in step S1204 in order to describe a case in which the displayed expansion menu needs to be updated (step S1204). Various processes can be performed as the process for updating the displayed expansion menu, but two processes will be described herein.

### (a) Resizing Preview Area

The displayed expansion menu is updated such that the preview area superimposed upon the expansion menu is resized and the entirety of the sheet is displayed. As a result, the user can check a preview of the entirety of the sheet in the preview area.

### (b) Expanding Expansion Menu

The expansion menu is resized in accordance with the expansion of the sheet. In the expansion menu, a preview of the sheet is displayed. If the sheet size is increased, therefore, the expansion menu is also expanded. In this case, the magnification (reduction ratio) of the preview of the sheet displayed in the preview area does not change before and after the expansion of the sheet.

If the displayed expansion menu is updated, the display area on the display unit 130 only displays a part of the expanded sheet. The part of the sheet displayed in the display area, therefore, is identified (step S1206). As a result, the user can easily understand which part of the sheet is currently displayed in the display area.

When the part of the sheet currently displayed in the display area is identified, a frame corresponding to the displayed part is displayed in the present embodiment. Alternatively, an area other than the displayed part may be shaded, or the luminance of the displayed part may be changed.

If the entirety of the expanded sheet is included in the display area, that is, if the entirety of the expanded sheet is displayed, the part of the sheet currently displayed need not be identified, or the entirety of the sheet may be identified.

### 1.4.4 Process for Updating Displayed Sheet

The process for updating a displayed sheet will be described with reference to FIG. 9. The process for updating a displayed sheet is achieved when the control unit 110 reads and executes the sheet display update program 158 stored in the storage unit 140.

Whether a displayed sheet needs to be updated is determined (step S1302). In this determination, for example, whether the expanded sheet is included in the display area is determined. Alternatively, the user may make settings relating to update of a displayed sheet, and whether to update the displayed sheet may be determined on the basis of the settings.

If the displayed sheet is to be updated, an operation in step S1304 is performed.

More specifically, the display area is resized such that the display area includes the entirety of an expansion (step S1304). Since the display area has been resized, the displayed sheet is updated (step S1306).

### 1.5. Example of Operation

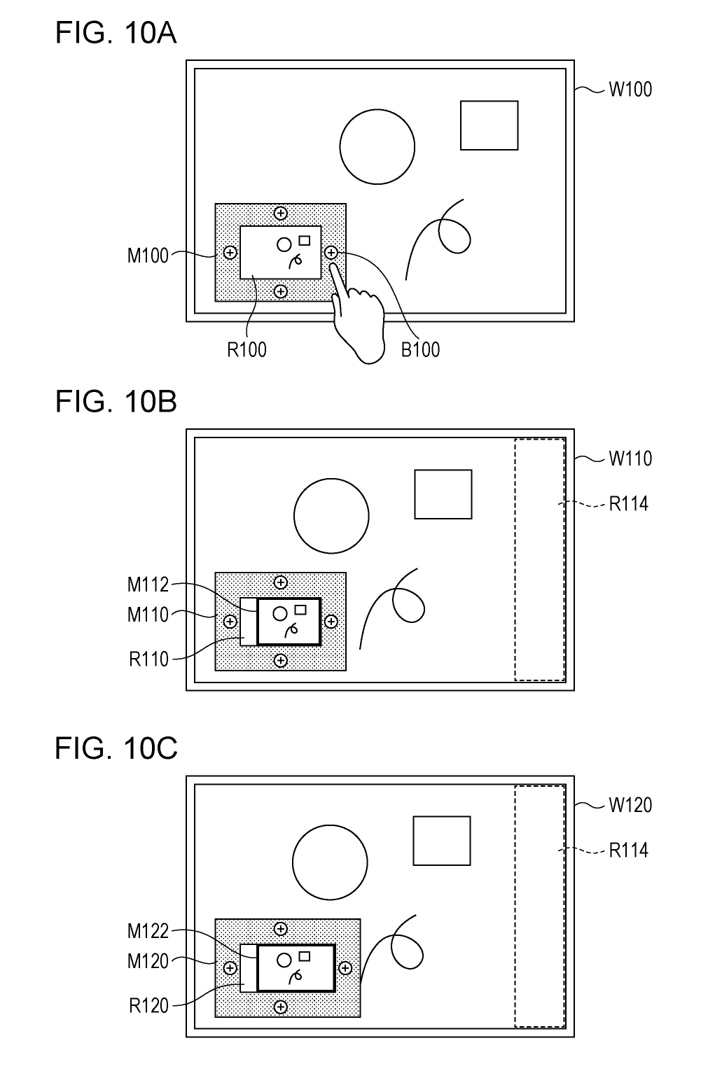

An example of an operation according to the present embodiment will be described with reference to FIGS. 10A to 10C. FIG. 10A illustrates an example of a display screen W100 on which a sheet included in a display area is displayed. A plurality of objects are arranged on the sheet, and an expansion menu M100 is called and superimposed upon the sheet. Although the expansion menu M100 is superimposed upon the sheet in FIG. 10A, the expansion menu M100 may be displayed in another area, instead.

In the expansion menu M100, a preview of the currently displayed sheet is displayed in a preview area R100. In the expansion menu M100, expansion buttons are displayed in four directions. Although the preview area R100 is included in the expansion menu M100, the preview area R100 may be displayed in an area different from the expansion menu M100, instead.

If the user touches (taps) a rightward expansion button B100, a display screen W110 illustrated in FIG. 10B is displayed.

In the display screen W110, the sheet size has been increased rightward, and the sheet has moved to the left so that an expansion area R114 is included in the display screen W110. That is, the objects arranged on the sheet have moved to the left by the size of the expansion area R114.

In a preview area R110 included in an expansion menu M110, a new preview image of the sheet is displayed. At this time, since the size of the sheet and the size of a displayed part of the sheet are different from each other, a frame M112 for identifying the currently displayed part of the sheet is displayed in the preview image.

Alternatively, as illustrated in FIG. 10C, when the sheet size has been increased, the expansion menu M120 may be expanded. In this case, a preview area R120 has also become larger than the preview area R110 in accordance with the size of the expanded sheet.

In FIG. 10C, too, the currently displayed part of the sheet is indicated by a frame M122.

When a currently displayed part of a sheet can be identified in a preview area as described above, the user can easily understand the currently displayed part of the sheet and how much the sheet has been expanded.

According to the present embodiment, a sheet can be easily expanded using an expansion menu.

### 2. Second Embodiment

A second embodiment will be described. In the present embodiment, a displayed sheet is not updated. More specifically, as described above, a displayed sheet is not updated, for example, when the sheet has been expanded but the entirety thereof is included in the display area or when the user has made settings or performed an operation in such a way as not to update the displayed sheet. A functional configuration and processing flows according to the present embodiment are basically the same as those according to the first embodiment, and differences from the first embodiment will be mainly described.

More specifically, a process performed when it has been determined in the process for updating a displayed sheet illustrated in FIG. 9 that the displayed sheet need not be updated (NO in step S1302) will be described. Since it has been determined in step S1302 that the displayed sheet need not be updated, the displayed sheet remains the same even after the sheet size is increased.

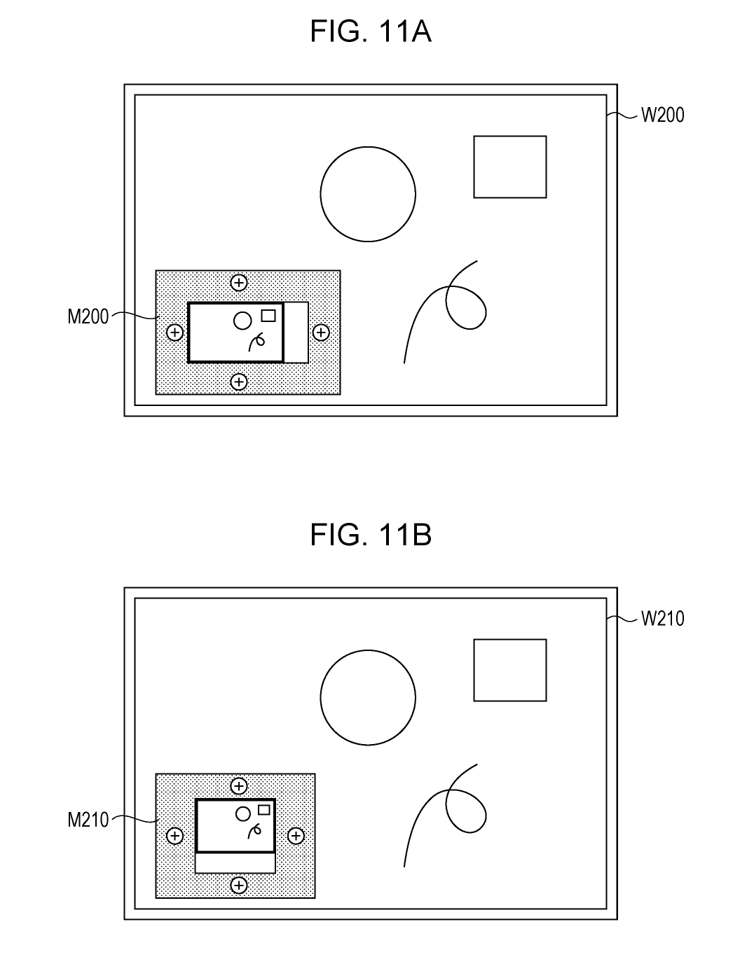

FIG. 11A illustrates a display screen W200 as an example of a display screen according to the second embodiment. In the display screen W200, an expansion menu M200 is displayed. The display screen W200 illustrated in FIG. 11A is displayed after the sheet size is increased rightward (e.g., after FIG. 10A).

In the display screen according to the present embodiment, a displayed sheet is not updated even after the sheet size is increased. That is, currently displayed objects remain at the same positions before and after expansion.

As a result, in the present embodiment, the user can expand a sheet while keeping objects at the same positions.

As another example, FIG. 11B illustrates a display screen W210 after the sheet size is increased downward. In FIG. 11B, a preview image whose sheet size has been increased downward is displayed. The size of the expansion menu M210 has not changed from that illustrated in FIG. 10A, and the size of the preview area is also the same. That is, the preview image has been reduced so that the entirety of the preview image is displayed.

Although the first and second embodiments have been individually described herein, the first and second embodiments may be combined with each other insofar as no contradiction is caused.

### 3. Third Embodiment

A third embodiment will be described. In the present embodiment, a preview image is not displayed in the expansion menu. A functional configuration and processing flows according to the present embodiment are the same as those according to the first embodiment, and differences from the first embodiment will be mainly described.

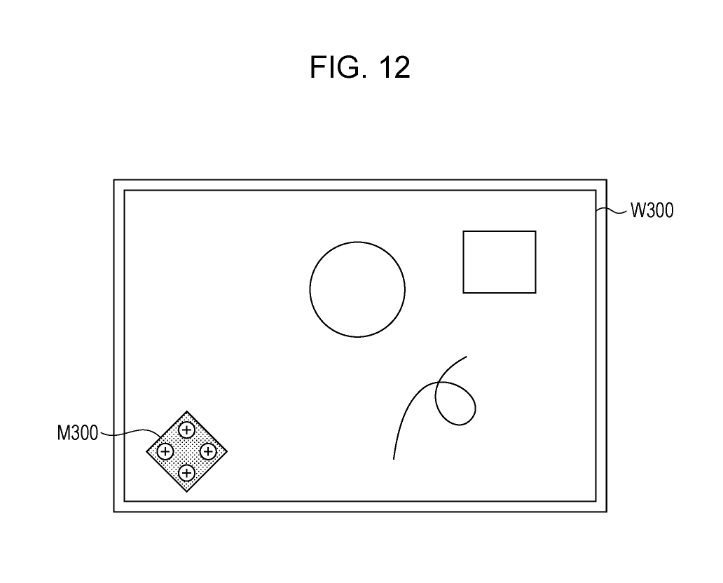

FIG. 12 illustrates an example of a display screen W300 according to the present embodiment. An expansion menu M300 displayed in a display screen W300 does not include a sheet preview image, and only expansion buttons are displayed.

In the present embodiment, therefore, the expansion menu need not be updated in step S1202 (NO in step S1202). That is, the same expansion menu is displayed even after a sheet is expanded.

According to the present embodiment, an expansion menu including only operation buttons for expanding a sheet can be used. As a result, a small expansion menu can be displayed, for example, when the display area is not large or when the user desires to use the display area for a sheet as much as possible.

### 4. Fourth Embodiment

A fourth embodiment will be described. In the present embodiment, an operation for changing the display area can be performed without changing the size of the expansion menu. A functional configuration and processing flows according to the present embodiment are the same as those according to the first embodiment, and differences from the first embodiment will be mainly described.

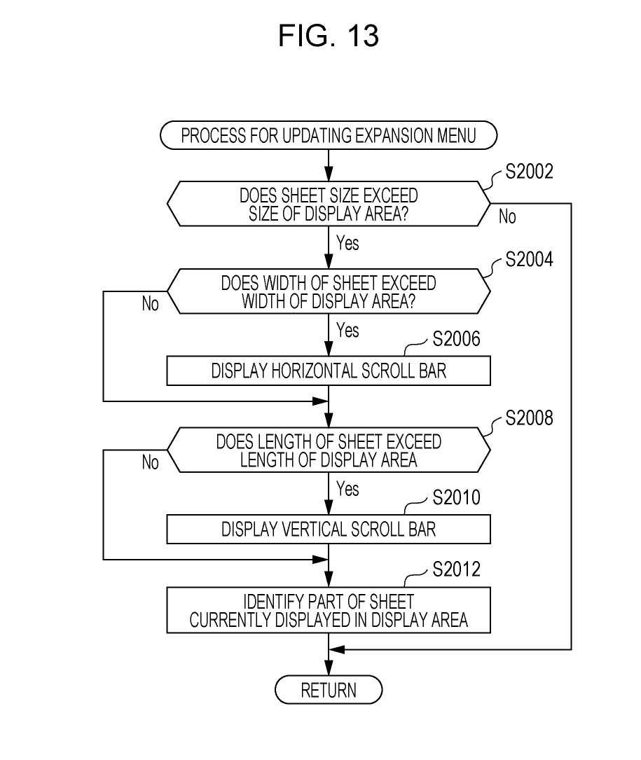

The fourth embodiment is obtained by replacing the process for updating the expansion menu according to the first embodiment illustrated in FIG. 8 with a process illustrated in FIG. 13.

First, whether the sheet size exceeds the current size of the display area is determined (step S2002). If the sheet size exceeds the current size of the display area (YES in step S2002), a scroll bar is displayed in the expansion menu.

More specifically, first, the sheet size and the size of the display area are compared with each other, and whether the width of a sheet exceeds the width of the display area is determined (step S2004). If so, a horizontal scroll bar is displayed (YES in step S2004→step S2006).

Next, whether the length of the sheet exceeds the length of the display area is determined (step S2008). If so, a vertical scroll bar is displayed (YES in step S2008→step S2010).

The part of the sheet currently displayed in the display area is then identified in the preview area (step S2012). Although the display area is indicated by a frame in the present embodiment, color or luminance may be used to indicate the display area, instead. Alternatively, the color or the luminance of an area other than the display area may be changed.

Although a scroll bar is displayed in the above process, a scroll bar may be removed when unnecessary. If a result of step S2004 is NO and a scroll bar has been displayed, for example, the scroll bar may be removed.

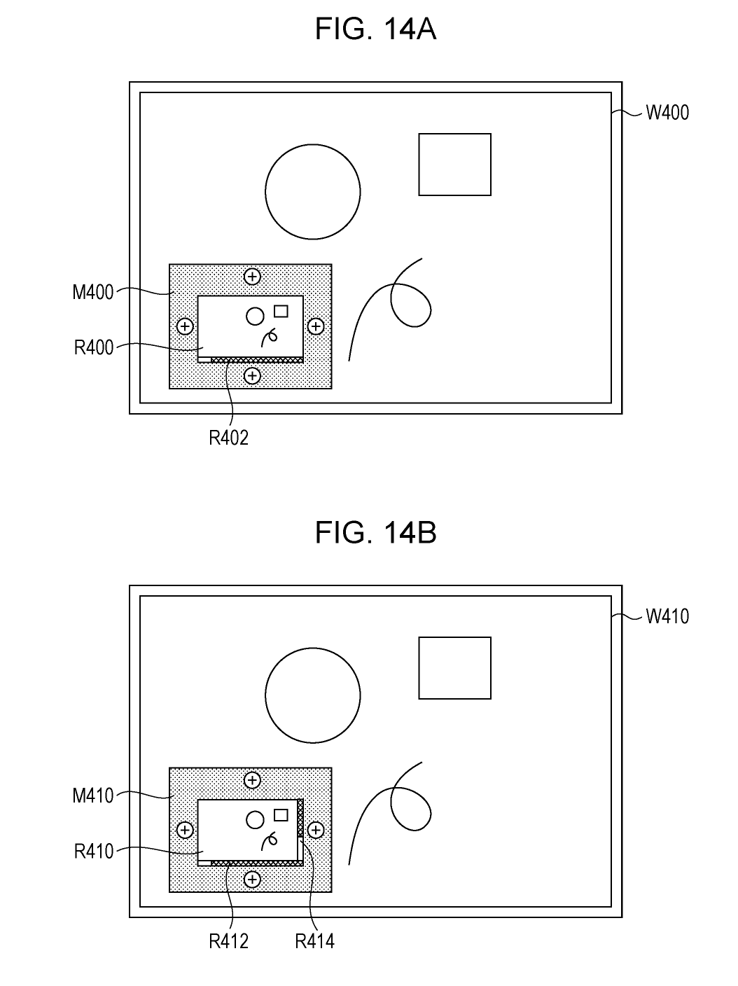

FIG. 14A illustrates an example of a display screen W400 according to the present embodiment. An expansion menu M400 displayed in the display screen W400 includes a sheet preview image in an area R400. It is assumed in the present embodiment that the sheet size exceeds the size of the display area. In this case, a scroll bar is displayed in a scroll operation area R402. The user can change a displayed part of the sheet by operating the scroll bar displayed in the scroll operation area R402.

That is, in the present embodiment, the expansion menu includes an expansion operation area in which expansion buttons are displayed and a preview display area in which a preview image is displayed.

The preview display area includes the scroll operation area R402. Although the preview display area includes the scroll operation area R402 in the present embodiment, another area may include the scroll operation area R402, instead. For example, the expansion operation area and the scroll operation area R402 may be integrated with each other. Alternatively, areas such as the scroll operation area R402 may be displayed or removed as necessary. The scroll operation area R402, in particular, need not be displayed when unnecessary.

In a display screen W410 illustrated in FIG. 14B, for example, scroll operation areas R412 and R414 are displayed in a preview display area R410 of an expansion menu M410. When vertical and horizontal scroll bars are displayed, the user can easily move a preview image.

### 5. Fifth Embodiment

A fifth embodiment will be described. In the present embodiment, when a sheet is expanded, the sheet is scaled down so that the entirety of the sheet is included in the display area. A functional configuration and processing flows according to the present embodiment are basically the same as those according to the first embodiment, and differences from the first embodiment will be mainly described.

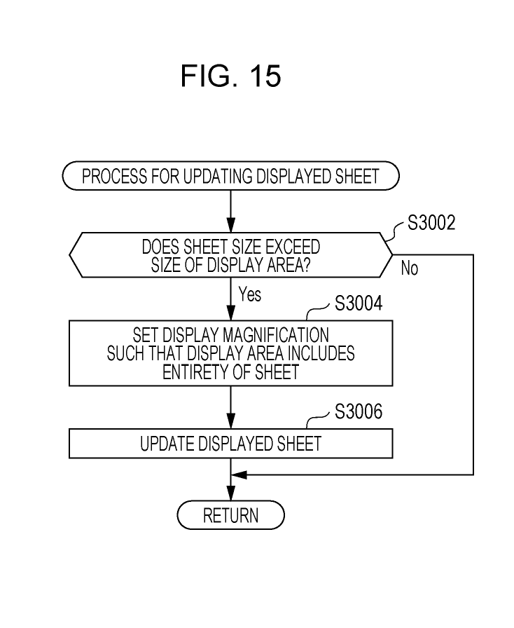

The fifth embodiment is obtained by replacing the process for updating a displayed sheet according to the first embodiment illustrated in FIG. 9 with a process illustrated in FIG. 15.

First, whether the sheet size exceeds the current size of the display area is determined (step S3002). If the sheet size exceeds the current size of the display area (YES in step S3002), display magnification is set such that the display area includes the entirety of the sheet (step S3004). The displayed sheet is then updated on the basis of the set display magnification (step S3006).

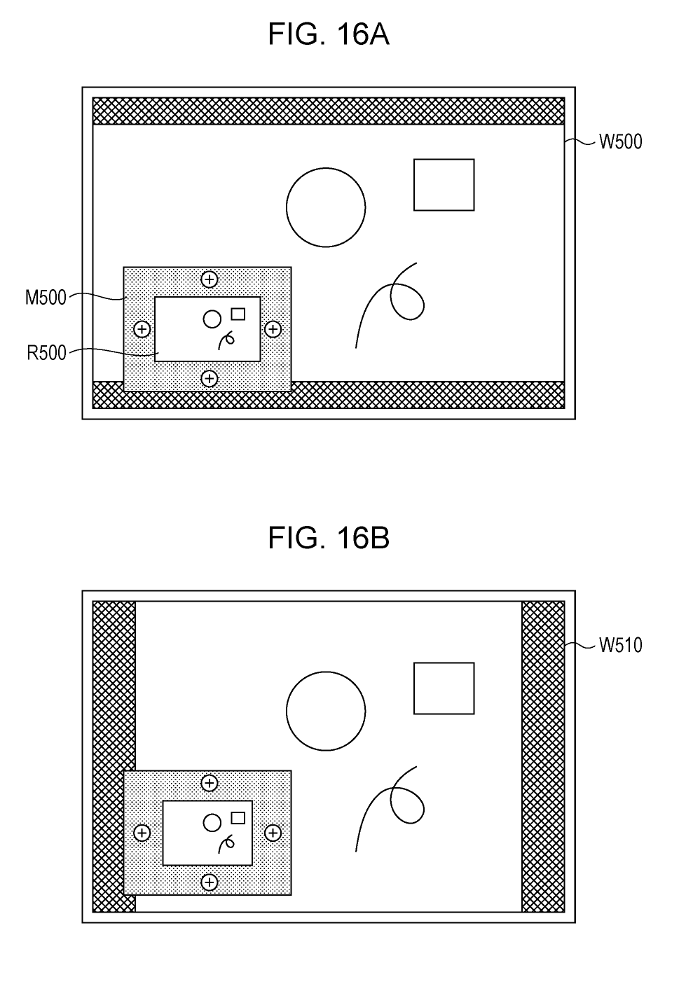

FIG. 16A illustrates an example of a display screen W500 according to the present embodiment. An expansion menu M500 displayed in the display screen W500 includes a sheet preview image in an area R500. It is assumed in the present embodiment that the sheet size exceeds the size of the display area. In this case, the entirety of the sheet is displayed in the display screen W500 by scaling down the sheet. In FIG. 16A, an example in which the sheet size is increased rightward is illustrated.

A display screen W510 illustrated in FIG. 16B illustrates a case in which the sheet has been expanded upward. In this case, the sheet size exceeds the display area, and the entirety of the sheet is displayed in the display screen W510 by scaling down the sheet.

Here, the sheet is scaled down so that the length or the width of the sheet, whichever exceeds the size of the display area, becomes equal to or smaller than the size of the display area. If the sheet size is increased rightward (FIG. 16A) and then the sheet size is increased upward (FIG. 16B), for example, the sheet is scaled down so that both the length and the width of the sheet become equal to or smaller than the size of the display area.

In the present embodiment, the scale of a sheet is automatically changed after the sheet is expanded, and the user can view the entirety of the sheet.

### 6. Sixth Embodiment

A sixth embodiment will be described. In the present embodiment, when a sheet is expanded, a sheet preview image is scaled down so that the expansion menu includes the entirety of the sheet preview image. A functional configuration and processing flows according to the present embodiment are basically the same as those according to the first embodiment, and differences from the first embodiment will be mainly described.

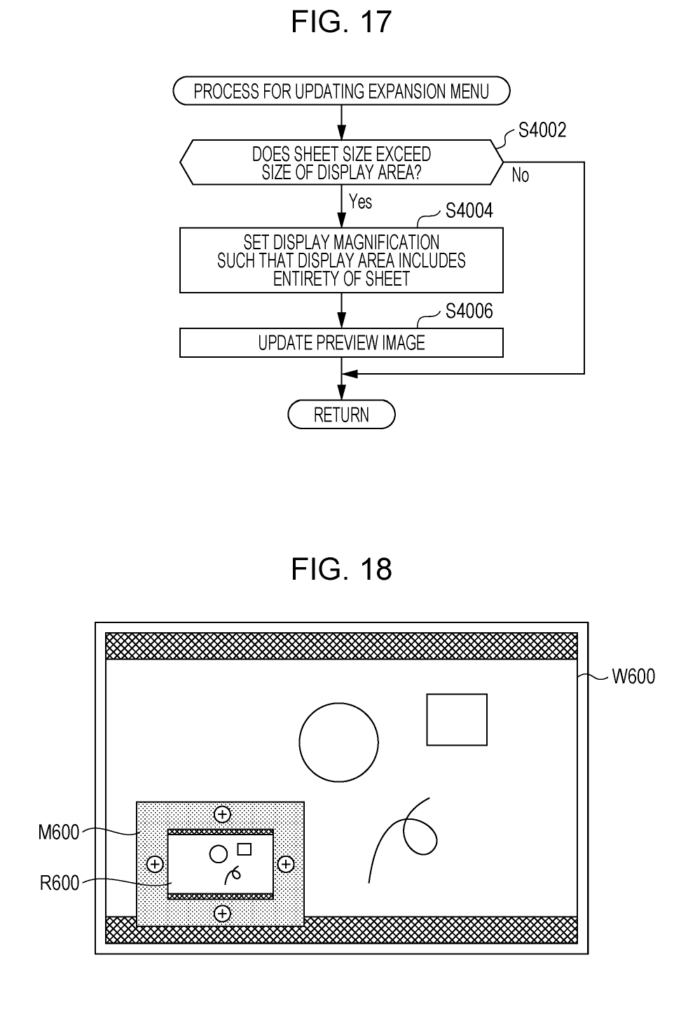

The sixth embodiment is obtained by replacing the process for updating the expansion menu according to the first embodiment illustrated in FIG. 8 with a process illustrated in FIG. 17.

First, whether the sheet size exceeds the current size of the display area is determined (step S4002). If the sheet size exceeds the current size of the display area (YES in step S4002), display magnification is set such that the display area includes the entirety of the sheet (step S4004). A preview image in the expansion menu is then updated on the basis of the set display magnification (step S4006).

FIG. 18 illustrates an example of a display screen W600 according to the present embodiment. An expansion menu M600 displayed in the display screen W600 includes a sheet preview image in an area R600. It is assumed in the present embodiment that the sheet size exceeds the display area. In this case, the sheet preview image is scaled down and the entirety thereof is displayed in the expansion menu M600. In the present embodiment, when a sheet is expanded, the scale of a sheet preview image in the expansion menu is automatically changed, and the user can easily select the entirety of the sheet in the expansion menu.

### 7. Seventh Embodiment

A seventh embodiment will be described. In the present embodiment, the display magnification of the preview display area can be arbitrarily changed or the expansion menu can be resized. A functional configuration and processing flows according to the present embodiment are basically the same as those according to the first embodiment, and differences will be mainly described.

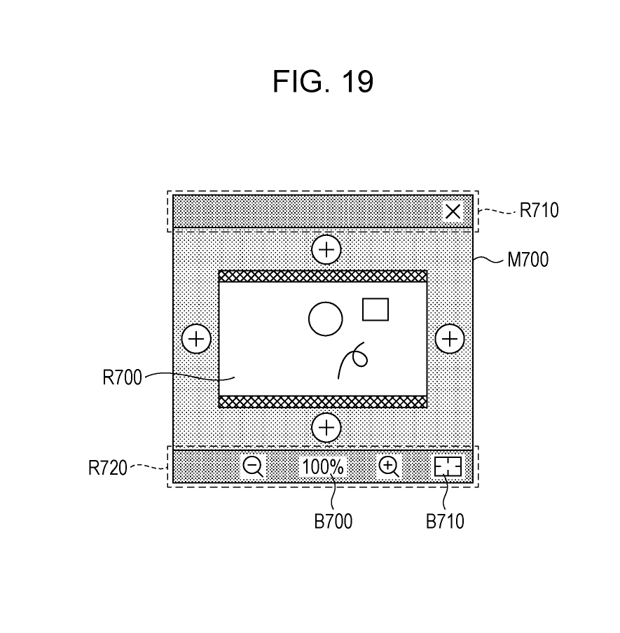

In the seventh embodiment, an expansion menu M700 illustrated in FIG. 19 is displayed as the expansion menu. The expansion menu M700 replaces the expansion menu displayed, for example, in the first or sixth embodiment.

The expansion menu M700 includes a preview image of the entirety of the sheet in a preview display area R700. The display magnification of the preview image of the entirety of the sheet can be arbitrarily changed using a display magnification selection button B700, which will be described later.

A menu display operation area R710 and a preview image magnification change operation area R720 are also provided.

In the menu display operation area R710, function buttons for operating the expansion menu M700 and the like are displayed. In this area, function buttons and selection areas for moving, resizing, and removing the expansion menu M700 and dividing the preview display area R700, for example, are displayed.

In the preview image magnification change operation area R720, the display magnification selection button B700 and a unity magnification button B710 are displayed. By selecting the display magnification selection button B700, the display magnification of the preview image can be changed. By selecting the unity magnification button B710, a display magnification of 100% can be achieved at any time. Depending on the display magnification, the expansion menu M700 may be resized in accordance with the preview image or a scroll bar may be displayed.

These areas may be displayed in the expansion menu M700 or may be displayed in another area (e.g., an area different from the expansion menu M700). Various functional interfaces may be provided as necessary.

### 8. Eighth Embodiment

An eighth embodiment will be described. In the present embodiment, a plurality of expansion buttons are selected. A functional configuration and processing flows according to the present embodiment are basically the same as those according to the first embodiment, and differences will be mainly described.

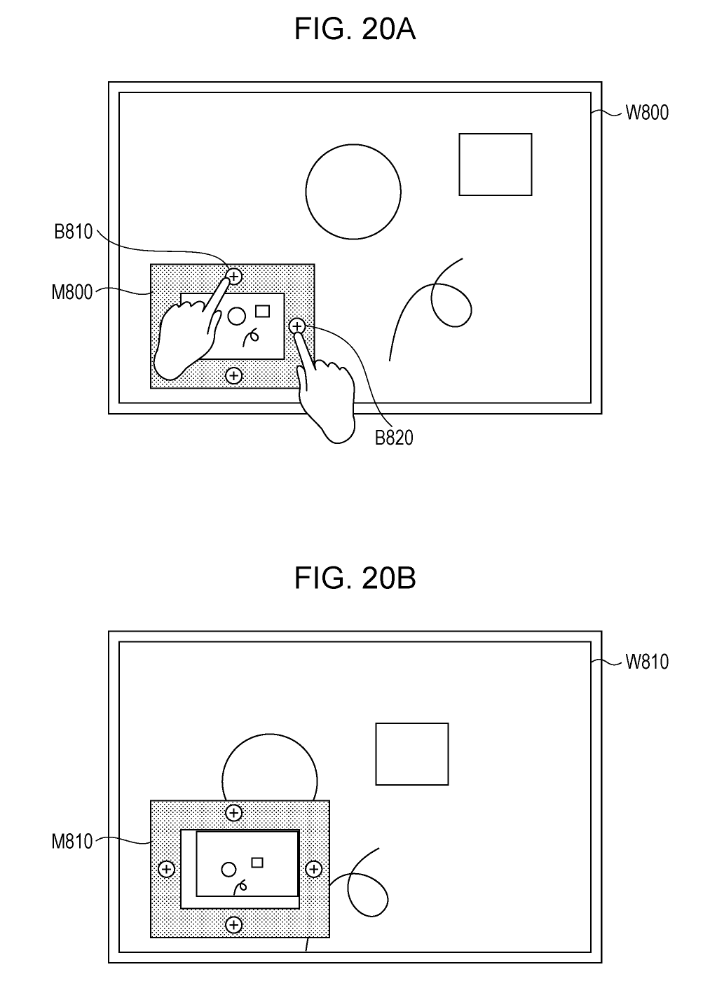

FIGS. 20A and 20B are diagrams illustrating an example of an operation according to the present embodiment. FIG. 20A illustrates an example of a display screen W800 according to the present embodiment. An expansion menu M800 is displayed in the display screen W800.

Here, the user selects an expansion button B810 for expanding a sheet upward and an expansion button B820 for expanding a sheet rightward. In this case, in step S1102 in the process for expanding a sheet illustrated in FIG. 7, for example, the upward and rightward directions are determined as expansion directions. The sheet is therefore expanded upward and rightward, and the sheet size increases.

FIG. 20B illustrates a display screen W810 obtained after the sheet size is increased. The sheet has been expanded in an upper-right direction (upward and rightward directions) and updated. It can also be seen from an expansion menu M810 that the sheet size has been increased in the upper-right direction.

According to the present embodiment, when the user desires to increase the sheet size in a plurality of directions, the user can easily increase the sheet size.

Although an example in which a sheet is expanded in two directions by selecting two expansion buttons has been described in the present embodiment, a middle point between two expansion buttons may be selected, instead. That is, a sheet may be expanded by selecting a middle point (i.e., an upper-right corner of the expansion menu M800) between the expansion buttons B810 and B820.

That is, the expansion direction is determined as a direction relative to the center (around the center) of the expansion menu M800 (a preview image), and a sheet is expanded in the expansion direction.

Although a sheet is expanded in two directions in the present embodiment for convenience of description, a sheet may be expanded in three or four (all) directions, instead. In addition, there may be an operation capable of expanding a sheet in a plurality of directions and an operation with which a sheet can be expanded only in one direction.

### 9. Ninth Embodiment

A ninth embodiment will be described. In the present embodiment, a size by which a sheet is to be expanded can be set stepwise by performing a certain operation. A functional configuration and processing flows according to the present embodiment are basically the same as those according to the first embodiment, and differences will be mainly described.

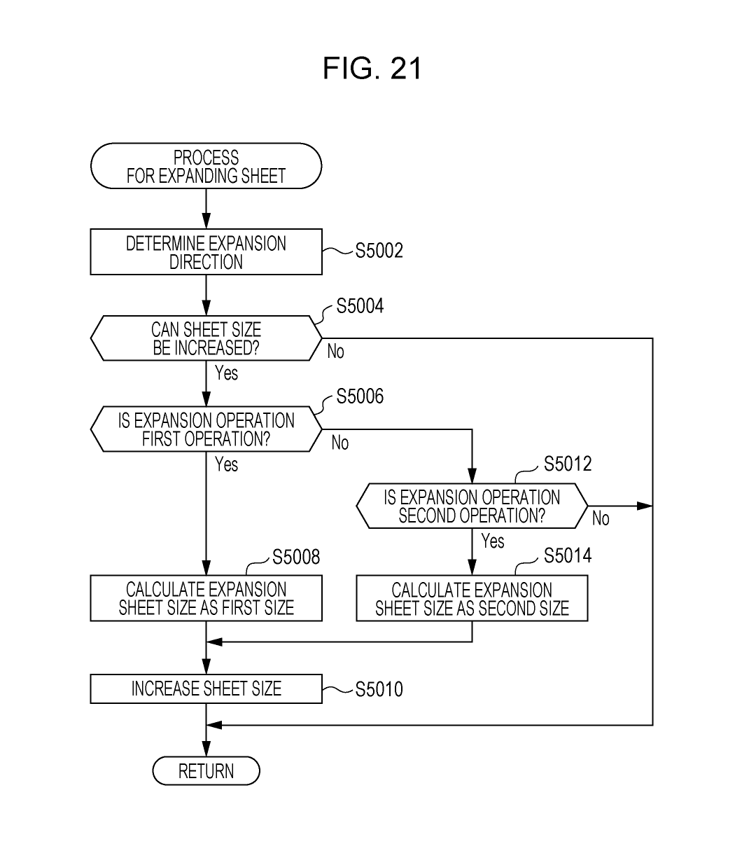

A ninth embodiment is obtained by replacing the process for expanding a sheet according to the first embodiment illustrated in FIG. 7 with a process illustrated in FIG. 21.

First, the user performs an operation for expanding a sheet to determine an expansion direction (step S5002). If the sheet size can be increased (YES in step S5004), whether the expansion operation is a first operation is determined (step S5006). If the expansion operation is the first operation, an expansion sheet size is calculated as a first size (YES in step S5006→step S5008).

If the expansion operation is a second operation, on the other hand, the expansion sheet size is calculated as a second size (NO in step S5006→YES in step S5012→step S5014). In the present embodiment, other operations do not expand a sheet (NO in step S5006→NO in step S5012).

The sheet is then expanded to the calculated sheet size, namely the first size or the second size (step S5010).

The user can easily perform the first and second operations in the following exemplary manners:
A tap for the first operation, a double-tap for the second operation
A tap with a finger for the first operation, a tap with two fingers for the second operation
A tap with a hand for the first operation, a touch with a hand and a tap with the other hand for the second operation
Different numbers of taps for the first and second operations

The first size may be smaller than the second size, or the first size may be larger than the second size. In addition, the first size may be achieved through expansion based on the number of pixels, and the second size may be achieved through expansion based on an expansion ratio. Alternatively, the second size may be achieved through expansion based on a fixed format. For example, when the second operation has been performed, a sheet may be automatically expanded to A4 size.

### 10. Tenth Embodiment

A tenth embodiment will be described. Although the sheet size is increased in the above embodiments, the sheet size is reduced by performing a certain operation in the present embodiment. A functional configuration and processing flows according to the present embodiment are basically the same as those according to the first embodiment, and differences will be mainly described.

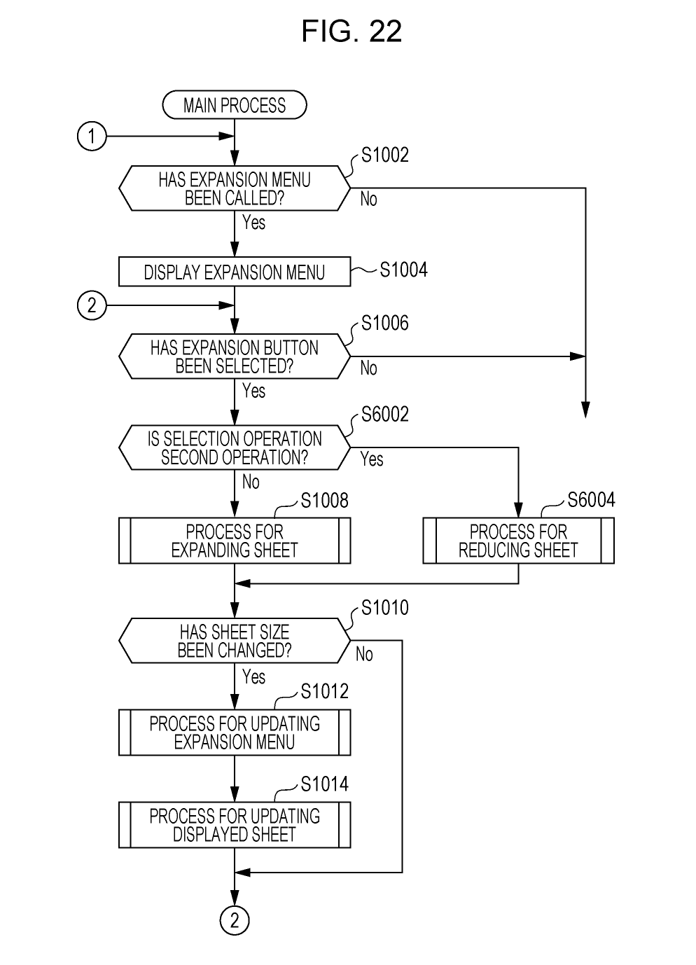

The tenth embodiment is obtained by replacing a part of the main process according to the first embodiment illustrated in FIG. 6 with a process illustrated in FIG. 22 (steps S1020 and later are omitted in FIG. 22 for convenience of description).

That is, in addition to the main process according to the first embodiment, if an expansion button is selected (YES in step S1006), whether the selection operation is the second operation is determined (step S6002). If the selection operation is a normal operation, the sheet is expanded as in the first embodiment (NO in step S6002→step S1008). If the second operation is performed, a process for reducing a sheet is performed (YES in step S6002→step S6004).

Here, the sheet is reduced in a direction corresponding to the selected expansion button (a reduction button in this case). As a result, an expanded sheet can be reset to an original size thereof or made smaller than the original size.

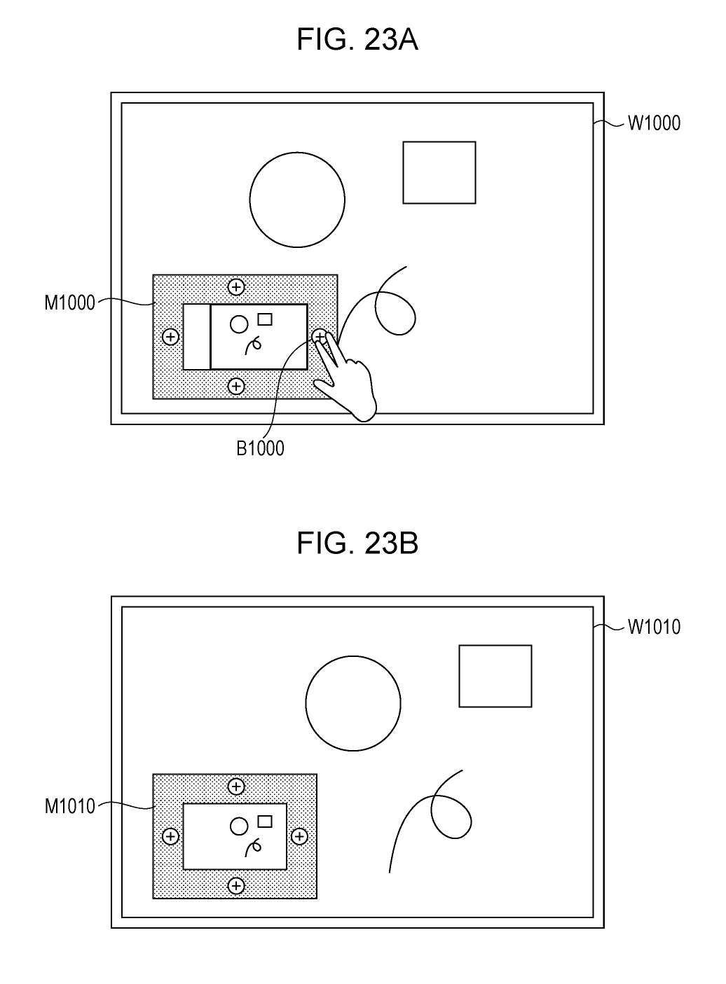

FIG. 23A illustrates an example of a display screen W1000 according to the present embodiment. An expansion menu M1000 displayed in the display screen W1000 includes expansion buttons. If an expansion button is touched (tapped) by two fingers as the second operation, the expansion button functions as a reduction button. If the user selects a reduction button B1000 with two fingers, a sheet is reduced. As illustrated in FIG. 23A, the reduction button B1000 may include a “−” sign instead of a “+” sign.

FIG. 23B illustrates a display screen W1010 displayed after the sheet is reduced. It can also be seen from the expansion menu M1010 that the sheet has been reduced.

According to the present embodiment, unlike in the above embodiments, a sheet can be reduced.

Alternatively, a direction of an operation may be identified and an operation for expanding a sheet and an operation for reducing a sheet may be distinguished from each other on the basis of a position of a touch and a type of operation (e.g., the number of touches). A “−” sign may be displayed in the case of the operation for reducing a sheet, and a sheet may be reduced if the “−” sign is selected.

### 11. Eleventh Embodiment

An eleventh embodiment will be described. In the eleventh embodiment, information regarding an expanded sheet is stored as history information, and the sheet is then reset to an original size thereof on the basis of the history information.

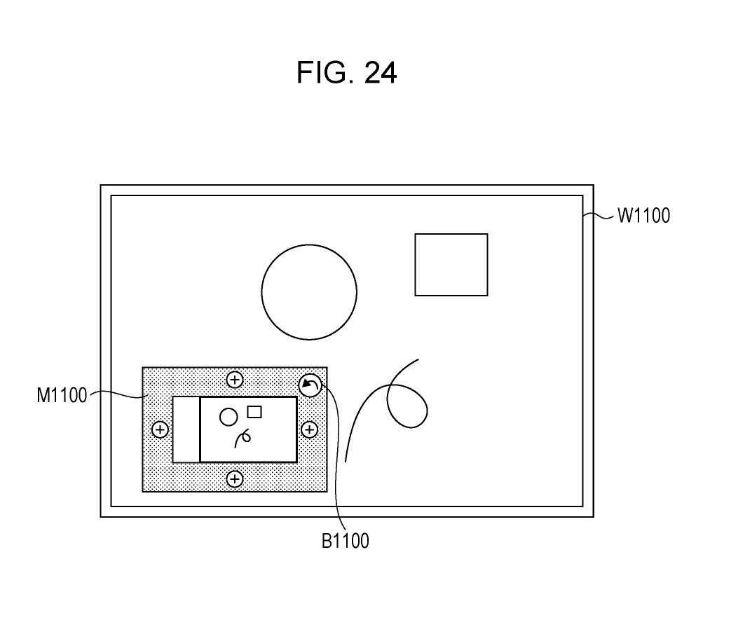

FIG. 24 illustrates a display screen W1100 displayed after the sheet size is increased rightward in FIG. 10A. By selecting an undo button B1100, the rightward expansion of the sheet is canceled, and the sheet returns to the state illustrated in FIG. 10A.

In addition, if a plurality of pieces of history information are stored, a plurality of operations performed on a sheet can be canceled. In this case, the operations described in the above embodiments are used to control an expansion menu M1100 and a displayed sheet.

If a new object is arranged halfway through the operation for expanding a sheet, the object, too, may be undone. Although the undo button B1100 is displayed in the expansion menu M1100 in the present embodiment, a standard undo function may be performed, instead.

### 12. Twelfth Embodiment

A twelfth embodiment will be described. In the twelfth embodiment, unlike in the above embodiments, the sheet size is increased in the expansion menu, but no operation buttons are displayed in the expansion menu.

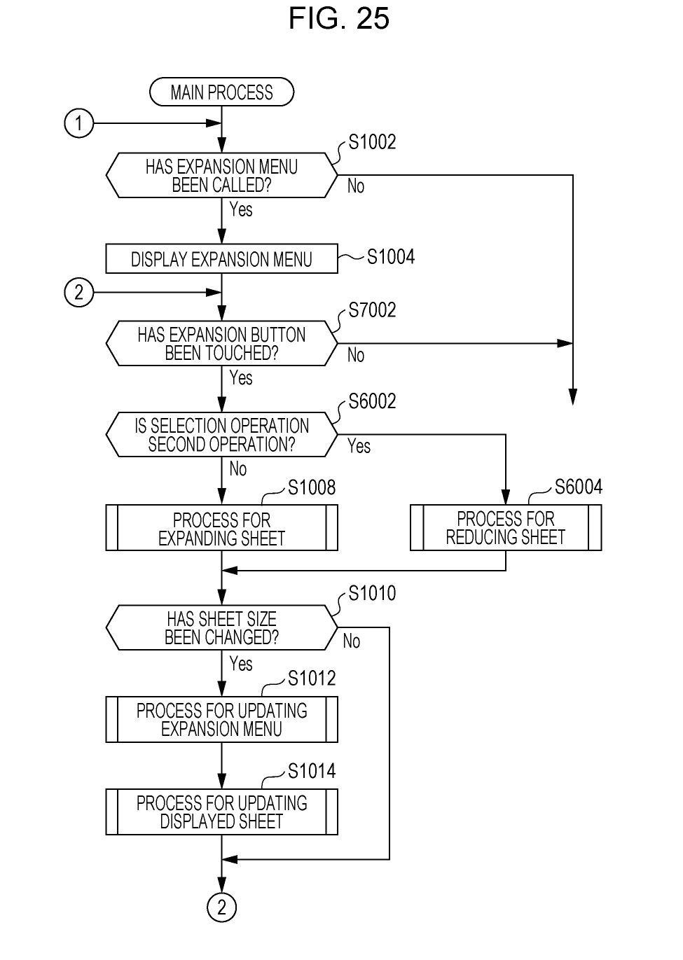

The present embodiment is obtained by replacing the main process according to the first embodiment illustrated in FIG. 6 with a main process illustrated in FIG. 25. The main process illustrated in FIG. 25 is obtained by replacing step S1006 in the main process illustrated in FIG. 6 with step S7002.

That is, in the present embodiment, an expansion operation may be detected after the expansion menu is displayed (step S7002). If an expansion operation is performed on the expansion menu, a sheet is expanded.

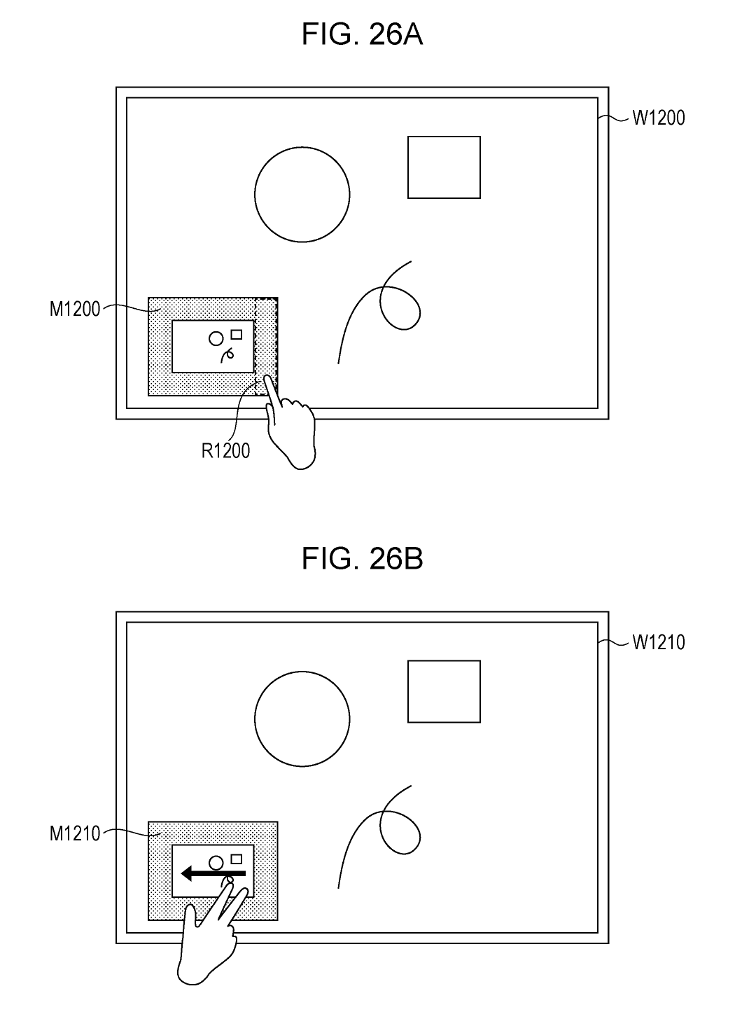

The operation for expanding a sheet will be described with reference to FIGS. 26A and 26B. In a display screen W1200 illustrated in FIGS. 26A and 26B, an expansion menu M1200 is displayed. The expansion menu M1200 includes a preview image. If the user touches an end of the preview image or an area outside the preview image, an operation for expanding a sheet is detected.

In FIG. 26A, an area R1200 outside the expansion menu M1200 is touched. As a result, a sheet is expanded rightward.

In a display screen W1210 illustrated in FIG. 26B, the user may swipe (with two fingers) the expansion menu M1210. Because the user swipes the expansion menu M1210 leftward, the sheet is expanded rightward, and the sheet size is changed.

According to the present embodiment, even if no expansion buttons are displayed in the expansion menu, an expansion operation can be detected, and the sheet size can be increased.

### 13. Thirteenth Embodiment

A thirteenth embodiment will be described. Whereas there is one display device 10 in the above embodiments, there are a plurality of displays in the present embodiment.

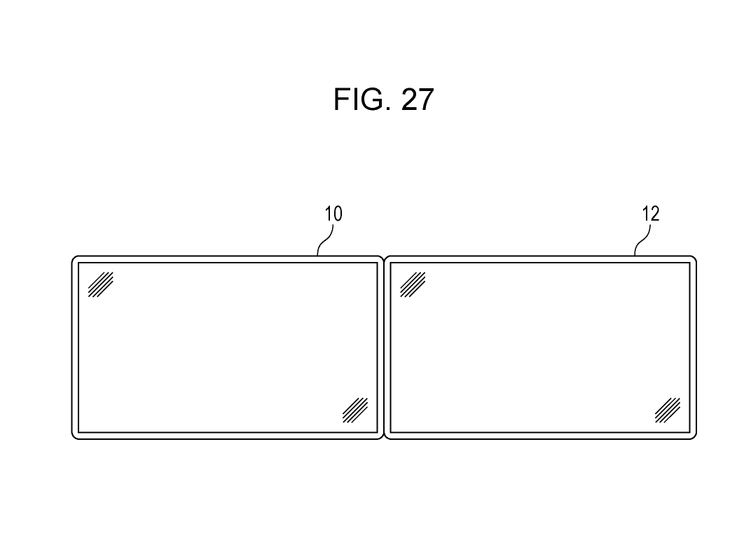

As illustrated in FIG. 27, the display device 10 and a display device 12 are arranged next to each other. That is, when there are a plurality of displays, the display devices 10 and 12 may be considered to together form one display area, or may be considered to form two different display areas.

When a sheet extends over the display devices 10 and 12, the display devices 10 and 12 may be considered to together form one display area. At this time, the expansion menu may be displayed in either of the two display devices 10 and 12.

### 14. Modifications

Although the above embodiments of the present disclosure have been described in detail with reference to the drawings, specific configurations are not limited to these embodiments. Designs that do not deviate from the scope of the present disclosure are also included in the aspects of the present disclosure.

Although a touch panel is used as the operation detection unit and a touch operation (tap operation) is performed in the above embodiments, a click operation may be performed using an external input device such as a mouse, instead.

A program operating on the device in each embodiment is a program (a program for causing a computer to function) for controlling a CPU or the like in such a way as to achieve the functions according to the embodiment. When processed, information handled in the device is temporarily accumulated in a temporary storage device (e.g., a random-access memory (RAM)), and then stored in a storage device such as a read-only memory (ROM), an HDD, or an SSD. The CPU reads, modifies, or rewrites the information as necessary.

When such a program is put on the market, the program may be stored in a portable recording medium, or may be transferred to a server computer through a network such as the Internet. In this case, it is needless to say that the present disclosure includes a storage device included in the server computer.

The present disclosure contains subject matter related to that disclosed in Japanese Priority Patent Application JP 2016-246989 filed in the Japan Patent Office on Dec. 20, 2016, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a sheet display unit that displays a sheet on which an object is to be arranged;
an expansion menu display unit that displays an expansion menu for receiving an input operation;
a determination unit that determines a direction in which the sheet is to be expanded on the basis of the input operation performed on the expansion menu; and
a sheet expansion unit that increases sheet size of the sheet in the determined direction.

2. The display device according to claim 1,
wherein the sheet display unit displays a part or entirety of the sheet as a display area and, if the sheet expansion unit has increased the sheet size, displays the sheet while updating the display area such that the display area includes an expansion of the sheet.

3. The display device according to claim 1,
wherein, if the sheet expansion unit has increased the sheet size, the sheet display unit sets a display magnification such that the display area includes entirety of the sheet, and displays the sheet with the display magnification.

4. The display device according to claim 1,
wherein the expansion menu display unit displays a preview image of the sheet in the expansion menu and provides the expansion menu with a selection area for selecting the direction in which the sheet is to be expanded, and
wherein the determination unit determines the direction in which the sheet is to be expanded on the basis of a selection operation performed in the selection area.

5. The display device according to claim 4,
wherein the expansion menu display unit identifies, in the preview image, a part or entirety of the sheet displayed by the sheet display unit.

6. The display device according to claim 4,
wherein, if the sheet expansion unit has increased the sheet size, the expansion menu display unit expands the expansion menu such that the expansion menu includes the preview image.

7. The display device according to claim 4,
wherein, if the sheet expansion unit has increased the sheet size, the expansion menu display unit sets a display magnification of the preview image such that the expansion menu includes the preview image, and displays the preview image with the display magnification.

8. A display method comprising:
displaying a sheet in which an object is to be arranged;
displaying an expansion menu for receiving an input operation;
determining a direction in which the sheet is to be expanded on the basis of the input operation performed on the expansion menu; and
increasing sheet size of the sheet in the determined direction.

9. A non-transitory computer-readable recording medium storing a program for causing a computer to perform operations comprising:
displaying a sheet in which an object is to be arranged;
displaying an expansion menu for receiving an input operation;
determining a direction in which the sheet is to be expanded on the basis of the input operation performed on the expansion menu; and
increasing sheet size of the sheet in the determined direction.
